(19) United States
(12) Patent Application Publication
(10) Pub. No.: US 2022/0325989 A1
(43) Pub. Date: Oct. 13, 2022

(54) MAGNETIC INDUCTION DART AND MAGNETIC INDUCTION DARTING SYSTEM

(71) Applicant: Asmeditron Inc., HSINCHU COUNTY (TW)

(72) Inventors: HUAI-FANG TSAI, HSINCHU COUNTY (TW); DIANN-FANG LIN, HSINCHU COUNTY (TW)

(21) Appl. No.: 17/717,222

(22) Filed: Apr. 11, 2022

(30) Foreign Application Priority Data
Apr. 12, 2021 (TW) 110113074

(51) Int. Cl. F41J 5/052; H01F 7/20; F42B 6/00

(52) U.S. Cl. CPC F41J 5/052; H01F 7/20; F42B 6/003; F41J 5/14

(57) ABSTRACT

A magnetic induction dart and a magnetic induction darting system are provided. The magnetic induction dart includes a barrel, a tip unit, and a magnetic unit. The first terminal and the second terminal of the barrel are oppositely disposed. The first terminal of the barrel has a recess. The tip unit is disposed at the first terminal of the barrel. The magnetic unit is disposed in the recess of the first terminal of the barrel. The tip unit is fixedly disposed in the barrel. The tip unit is in contact with the magnetic unit in the recess. The first terminal of the barrel further includes a first fixing structure. A first end of the tip unit includes a second fixing structure. The tip unit is fixedly connected to the first fixing structure of the barrel through the second fixing structure.

### CROSS-REFERENCE TO RELATED PATENT APPLICATION

This application claims the benefit of priority to Taiwan Patent Application No. 110113074, filed on Apr. 12, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a magnetic induction dart and a magnetic induction darting system, and more particularly to a magnetic induction dart and a magnetic induction darting system with a simple structure.

### BACKGROUND OF THE DISCLOSURE

Conventionally, a magnetic induction dart needs to be routinely magnetized, and the magnetization frequency of the magnetic induction dart is not high. Furthermore, when the magnetic induction dart is used in cooperation with a magnetic induction dart board, the problem of misjudgment in scoring is prone to occur.

Therefore, how to provide a magnetic induction dart and a magnetic induction darting system with a simple structure has become one of the important issues to be addressed in the application.

### SUMMARY OF THE DISCLOSURE

In response to the above-referenced technical inadequacies, the present disclosure provides a magnetic induction dart and a magnetic induction darting system.

In one aspect, the present disclosure provides a magnetic induction dart. The magnetic induction dart includes a barrel, a tip unit, and a magnetic unit. The barrel includes a first terminal and a second terminal. The first terminal and the second terminal of the barrel are oppositely disposed. A recess is disposed at the first terminal of the barrel. The tip unit is disposed at the first terminal of the barrel. The magnetic unit is disposed in the recess of the first terminal of the barrel. The tip unit is fixedly disposed in the barrel. The tip unit is in contact with the magnetic unit in the recess. The first terminal of the barrel further includes a first fixing structure. The tip unit includes a first end and a second end. The first end of the tip unit includes a second fixing structure. The tip unit is fixedly connected to the first fixing structure of the barrel through the second fixing structure.

In another aspect, the present disclosure provides a magnetic induction darting system. The magnetic induction darting system includes a magnetic induction dart and a magnetic induction dart board. The magnetic induction dart includes a barrel, a tip unit, and a magnetic unit. The barrel includes a first terminal and a second terminal. The first terminal and the second terminal of the barrel are oppositely disposed. A recess is disposed at the first terminal of the barrel. The tip unit is disposed at the first terminal of the barrel. The magnetic unit is disposed in the recess of the first terminal of the barrel. The tip unit is fixedly disposed in the barrel. The tip unit is in contact with the magnetic unit in the recess. The first terminal of the barrel further includes a first fixing structure. The tip unit includes a first terminal and a second terminal. The first end of the tip unit includes a second fixing structure. The tip unit is fixedly connected to the first fixing structure of the barrel through the second fixing structure. The magnetic induction dart board includes a plate, a plurality of induction circuits, and a sensing circuit. The plate includes a board surface and a back surface. The plurality of induction circuits are parallelly disposed with respect to the board surface. The plurality of induction circuits are staggered with each other to form a plurality of induction areas covering a plurality of target areas of the board surface. The sensing circuit is electrically connected to the induction circuits such that the plurality of induction circuits of a plurality of close-loop induction circuits to generate a plurality of induction signals when the magnetic induction dart is close to the board surface. The sensing circuit receives the plurality of induction signals from the plurality of induction circuits, and determines a location of the magnetic induction dart block on the induction signals.

Therefore, the magnetic induction dart provided by the present disclosure can utilize the magnetic unit to provide magnetic field for a long period of time, does not need magnetization often, and is easy to maintain. Furthermore, when the dart is thrown toward the magnetic induction dart board, a misjudgment does not easily occur. In addition, costs can be reduced by dispensing with the need for complex wiring of the induction area where the magnetic dart is located. These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a magnetic induction dart according to a first embodiment of the present disclosure;

FIG. 2 is another schematic view of the magnetic induction dart according to the first embodiment of the present disclosure;

FIG. 3 is another schematic view of the magnetic induction dart according to the first embodiment of the present disclosure;

FIG. 4 is a functional block diagram of a magnetic induction dart according to a second embodiment of the present disclosure;

FIG. 5 is a top view of a magnetic induction dart board according to the second embodiment of the present disclosure;

FIG. 6 is a schematic view of a magnetic induction darting system according to the second embodiment of the present disclosure;

FIG. 7A, FIG. 7B, and FIG. 7C are schematic cross-sectional views taken along line I-I of the magnetic induction dart board of FIG. 5;

FIG. 7D, and FIG. 7E are schematic cross-sectional views taken along line II-II of the magnetic induction dart board of FIG. 5; and

FIG. 8A, FIG. 8B and FIG. 8C show wiring arrangement of induction circuits according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

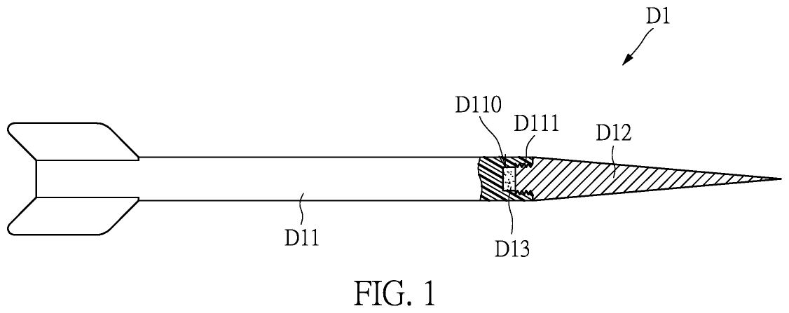

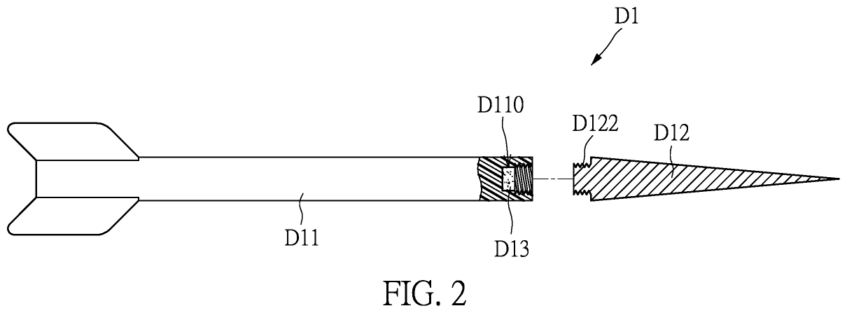

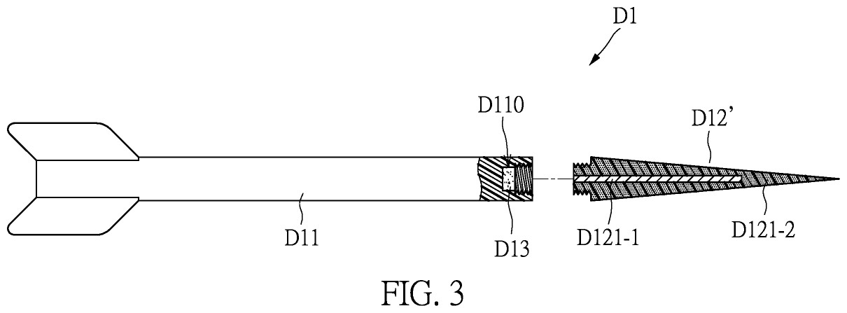

Referring to FIG. 1, FIG. 2, and FIG. 3, FIG. 1 is a schematic view of a magnetic induction dart according to a first embodiment of the present disclosure, FIG. 2 is another schematic view of the magnetic induction dart according to the first embodiment of the present disclosure, and FIG. 3 is another schematic view of the magnetic induction dart according to the first embodiment of the present disclosure.

A magnetic induction dart D1 includes a barrel D11, a tip unit D12, and a magnetic unit D13.

The barrel D11 includes a first terminal and a second terminal. The first terminal and the second terminal of the barrel D11 are oppositely disposed. A recess D110 is disposed in the first terminal of the barrel D11.

The tip unit D12 is disposed at the first terminal of the barrel D11. The magnetic unit D13 is disposed in the recess D110 of the first terminal of the barrel D11.

When the tip unit D12 is disposed at the first terminal of the barrel D11, the tip unit D12 is fixedly disposed in the barrel D11. The tip unit D12 is in contact with the magnetic unit D13 disposed in the recess D110.

The first terminal of the barrel D11 further includes a first fixing structure D111. The tip unit D12 includes a first end and a second end. The first end of the tip unit D12 includes a second fixing structure D122. The tip unit D12 is fixedly connected to the first fixing structure D111 of the barrel D11 through the second fixing structure D122. In this embodiment, the first fixing structure D111 is a first screw thread structure, and the second fixing structure D122 is a second screw thread structure. In other embodiments, the first fixing structure D111 and the second fixing structure D122 are fixing structures engaged to each other such as snaps or threads, and the present disclosure is not limited thereto.

The barrel D11 is made of at least one non-magnetic conductive material. The material of the barrel D11 is a plastic, a copper, or a rubber.

Referring to FIG. 1 and FIG. 2, the tip unit D12 is a metal needle.

In other words, when the tip unit D12 contacts the magnetic unit D13, the magnetic flux lines of the magnetic unit D13 are extended along the tip unit D12.

Referring to FIG. 3, a tip unit D12′ includes a metal strip D121-1 and an insulation layer D121-2. The insulation layer D121-2 is disposed outside of the metal strip D121-1. The insulation layer D121-2 is a hard polymer. The metal strip D121-1 may be disposed in the insulation layer D121-2 by insert molding.

In other words, the metal strip D121-1 of the tip unit D12′ contacts the magnet unit D13, and the magnetic flux lines of the magnetic unit D13 are extended along the tip unit D12′. The metal strip D121-1 is exposed on one side of the insulation layer D121-2 to contact the magnet unit D13, and the metal strip D121-1 is not exposed on the other side of the insulating layer D121-2. In addition, the insulation layer D121-2 at the second end of the tip unit D12′ is needle-shaped.

### Second Embodiment

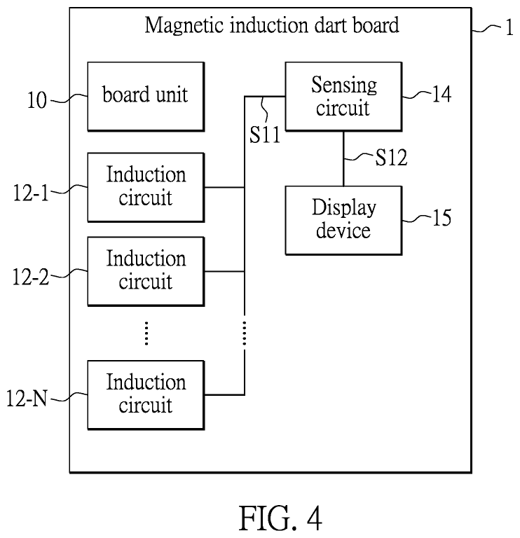

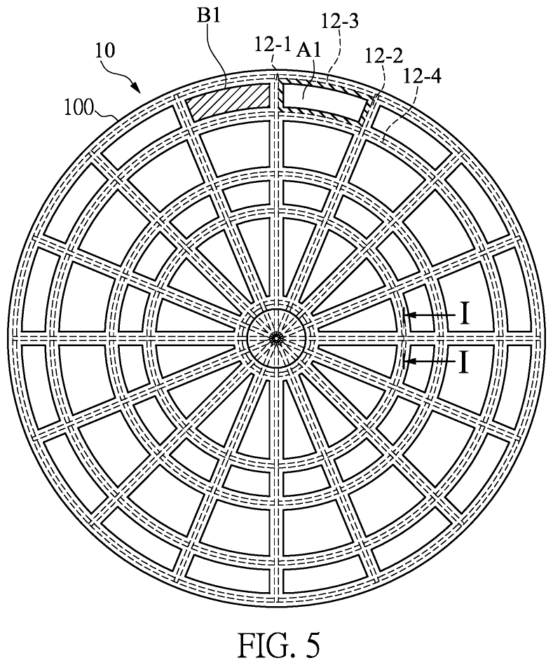

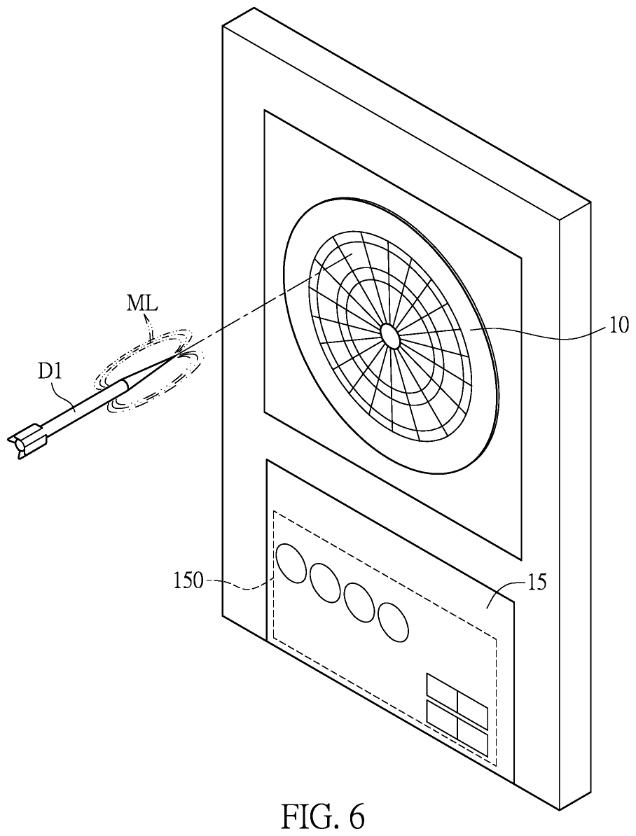

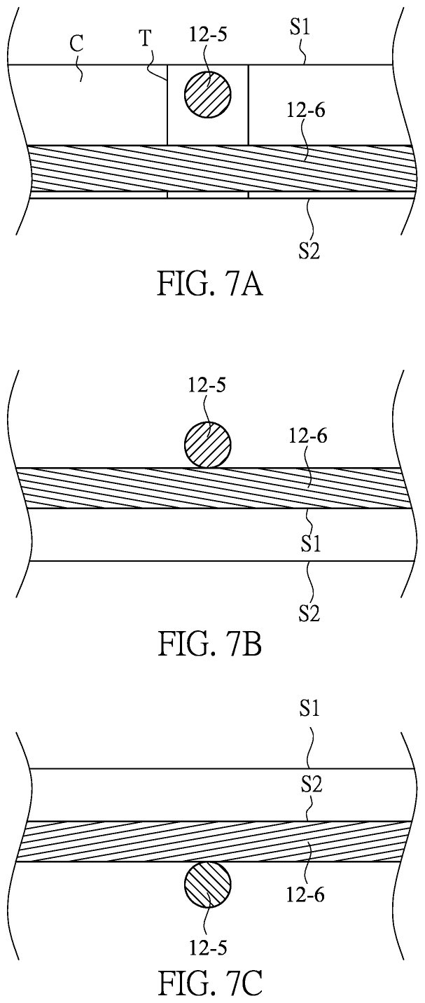

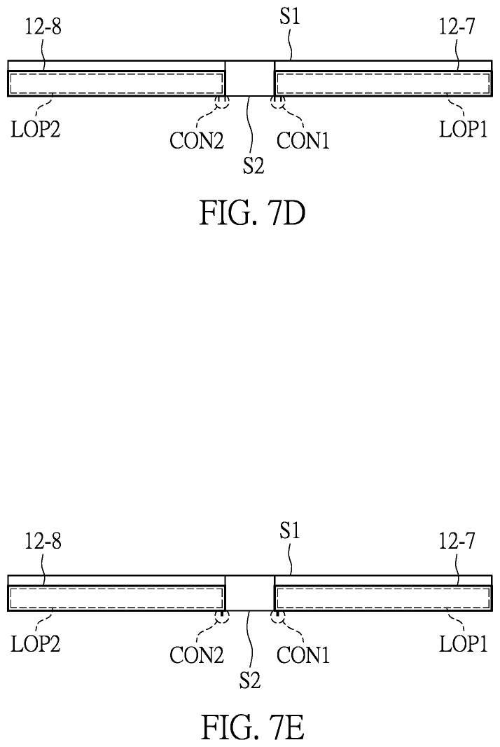

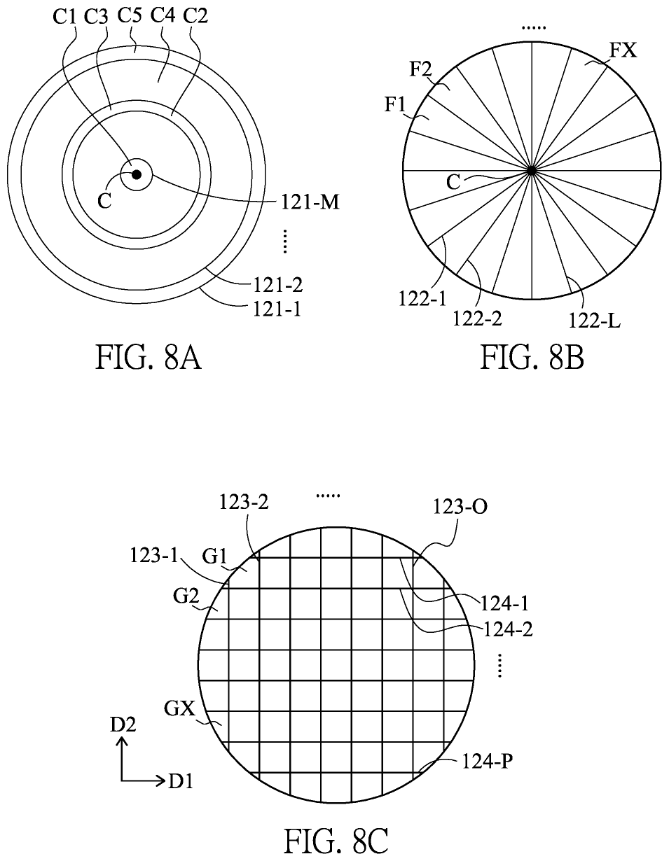

Referring to FIG. 4, FIG. 5, FIG. 6, FIG. 7A. FIG. 7B, FIG. 7C, FIG. 7D, FIG. 7E, FIG. 8A, FIG. 8B, and FIG. 8C, FIG. 4 is a functional block diagram of a magnetic induction dart according to a second embodiment of the present disclosure. FIG. 5 is a top view of a magnetic induction dart board according to the second embodiment of the present disclosure. FIG. 6 is a schematic view of a magnetic induction darting system according to the second embodiment of the present disclosure. FIG. 7A, FIG. 7B, and FIG. 7C are schematic cross-sectional views taken along line I-I of the magnetic induction dart board of FIG. 5. FIG. 7D, and FIG. 7E are schematic cross-sectional views taken along line II-II of the magnetic induction dart board of FIG. 5. FIG. 8A, FIG. 8B and FIG. 8C show wiring arrangement of induction circuits according to the second embodiment of the present disclosure.

A magnetic induction darting system SYS1 includes a magnetic induction dart D1, and a magnetic induction dart board 1.

In the embodiment, when the magnetic induction dart D1 is used to accompany with the magnetic induction dart board 1, and when the magnetic induction dart D1 is thrown toward the magnetic induction dart board 1, the magnetic induction dart board 1 detects on all areas thereof through magnetic induction to provide induction current to an induction circuit for getting the score.

The magnetic induction dart D1 includes a barrel D11, a tip unit D12, and a magnetic unit D13.

The barrel D11 includes a first terminal and a second terminal. The first terminal and the second terminal of the barrel D11 are oppositely disposed. A recess D110 is disposed in the first terminal of the barrel D11.

The tip unit D12 is disposed at the first terminal of the barrel D11. The magnetic unit D13 is disposed in the recess D110 of the first terminal of the barrel D11.

In the embodiment, the tip unit D12 is a metal needle. When the tip unit D12 is disposed at the first terminal of the barrel D11, the tip unit D12 is fixedly disposed in the barrel D11. The tip unit D12 contacts the magnetic unit D13 disposed in the recess D110.

Referring to FIG. 1 and FIG. 2, a first fixing structure D111 is disposed at the first terminal of the barrel D11. The tip unit D12 includes a first end and a second end. The first fixing structure D122 is disposed at the first end of the tip unit D12. The tip unit D12 is fixedly disposed in the first fixing structure D111 of the barrel D11 through the second fixing structure D122.

In this embodiment, the first fixing structure D111 is a first screw thread structure, and the second fixing structure D122 is a second screw thread structure. In other embodiments, the first fixing structure D111 and the second fixing structure D122 are fixing structures that are contact with each other, such as snap-fitting or threaded structures, and the present disclosure is not limited thereto.

In other embodiments, the tip unit D12 is a one-piece metal needle.

The barrel D11 is made of at least one non-magnetic conductive material. The material by which the barrel D11 is made of plastic, copper, or rubber.

Referring to FIG. 2, the tip unit D12 is a metal needle. In other words, when the tip unit D12 contacts with the magnetic unit D13, the magnetic flux lines of the magnetic unit D13 are extended along the tip unit D12.

Referring to FIG. 3, a tip unit D12′ includes a metal strip D121-1 and an insulation layer D121-2. The insulation layer D121-2 is disposed outside of the metal strip D121-1. The insulation layer D121-2 is a hard polymer. The metal strip D121-1 may be disposed in the insulation layer D121-2 by insert molding.

In other words, the metal strip D121-1 of the tip unit D12′ contacts with the magnet unit D13, and the magnetic flux lines of the magnet unit D13 are extended along the tip unit D12′. The metal strip D121-1 is exposed on one side of the insulating layer D121-2 to contact the magnet unit D13, and the metal strip D121-1 is not exposed on the other side of the insulation layer D121-2. In addition, the insulation layer D121-2 at the second end of the tip unit D12′ is needle-shaped. Since the insulation layer D121-2 of the tip unit D12′ of this embodiment is made of polymer, a material of the dart board surface can be selected accordingly.

Referring to FIG. 4, FIG. 5, FIG. 6, FIG. 7A, FIG. 7B, and FIG. 7C, FIG. 4 is a functional block diagram of a magnetic induction dart according to a second embodiment of the present disclosure. FIG. 5 is a top view of a magnetic induction dart board according to the second embodiment of the present disclosure. FIG. 6 is a schematic view of a magnetic induction darting system according to the second embodiment of the present disclosure. FIG. 7A, FIG. 7B, and FIG. 7C are schematic cross-sectional views taken along line I-I of the magnetic induction dart board of FIG. 5.

Referring to FIG. 1, a magnetic induction dart board 1 is provided in the first embodiment of the present disclosure. The magnetic induction dart board 1 includes a board unit 10, a plurality of induction circuits 12-1 to 12-N, and a sensing circuit 14.

Referring to FIG. 5 and FIG. 7A, the board unit 10 includes a plate 100 that has a board surface S1 and a back surface S2. The induction circuits 12-1 to 12-N are disposed in parallel with the board surface S1, and the induction circuits 12-1 to 12-N are in an intersecting arrangement with each other to form a plurality of induction areas A1 to cover a plurality of target areas B1 on the board surface S1.

Referring to FIG. 5, an induction area A1 that is marked is formed by the induction circuits 12-1 to 12-4, and the induction area A1 can cover multiple target areas B1. The plurality of induction areas A1 can respectively correspond to the plurality of target areas B1. An area of the induction area A1 should be greater than an area of the corresponding target area B1 in practice, but the present disclosure is not limited thereto.

Furthermore, the plate 100 can be made of permeable materials, such as wood, plastic, or sisal, and the induction circuits 12-1 to 12-N can be made of electrically conductive hard materials, such as iron, steel, stainless steel, aluminum, copper, cast iron, zinc, silver, tungsten, nickel or alloys of the aforementioned metals. The induction circuits can also be made by mold injection of electrically conductive hard plastics.

In other embodiments, the induction circuits 12-1 to 12-N can be disposed on the board surface S1 of the board unit 10, or inside of the board surface S1 of the board unit 10, or on the back surface S2 of the board unit 10.

In the embodiment as shown in FIG. 7A, the induction circuit 12-5 and the induction circuit 12-6 are disposed in the board unit 10. The plate 100 may have a plurality of blocks T for accommodating the induction circuit 12-5 and the induction circuit 12-6, and the induction circuit 12-5 and the induction circuit 12-6 may be attached to the plate 100 through a glue C. The glue C can be an insulating colloid, such as hard plastic, hot glue, PU resin, or other insulating adhesive materials. Surfaces of the induction circuit 12-5 and the induction circuit 12-6 can also be coated with insulation layers, and can be, for example, anodized layers, electroplating layers, insulating paint layers, etc., and the present disclosure is not limited thereto. In a specific embodiment, the induction circuit 12-5 and the induction circuit 12-6 can be spaced apart from each other at a predetermined distance via the glue C, thereby achieving the effect of insulation.

As shown in FIG. 7B and FIG. 7C, the induction circuit 12-5 and the induction circuit 12-6 can be disposed on the board surface S1 of the board unit 10 or the back surface S2 of the board unit 10. In this condition, the surfaces of the induction circuit 12-5 and the induction circuit 12-6 can be coated by the insulation layers. Therefore, even if the induction circuit 12-5 is directly in contact with the induction circuit 12-6, a short circuit between the induction circuit 12-5 and the induction circuit 12-6 does not occur.

On the other hand, the sensing circuit 14 and the induction circuits 12-1 to 12-N are used in cooperation to form a plurality of close-loop induction circuits as shown in FIG. 7D and FIG. 7E. In some embodiments, the induction circuit 12-7 and the induction circuit 12-8 can be disposed in the corresponding blocks T, and are extended along radial directions of the board unit 10. Furthermore, the induction circuit 12-7 and the induction circuit 12-8 surround portions of the back surface S2 of the board unit 10 to form a close-loop induction circuit LOP1 and a close-loop induction circuit LOP2, respectively.

The induction circuit 12-7 and the induction circuit 12-8 can respectively protrude from a central area of the back surface S2 of the board unit 10 to form connection portions CON1 and CON2. The induction circuit 12-7 is electrically connected to the sensing circuit 14 through the connection portion CON1 including two electrical pads, and the induction circuit 12-8 is electrically connected to the sensing circuit 14 through the connection portion CON2 including two electrical pads.

On the other hand, as shown in FIG. 7D, the induction circuit 12-7 and the induction circuit 12-8 can individually form the close-loop induction circuit LOP1 and the close-loop induction circuit LOP2, respectively. Or, as shown in FIG. 7E, a bridge circuit can be disposed between the induction circuit 12-7 and the induction circuit 12-8. The induction circuit 12-7 and the induction circuit 12-8 can protrude from the central area of the back surface S2 of the board unit 10 to form the connection portions CON1 and CON2 including a single electrical pad so as to be connected to the sensing circuit 14.

Referring to FIG. 4 and FIG. 5, when the sensing circuit 14 is electrically connected to the induction circuits 12-1 to 12-N, the induction circuits 12-1 to 12-N form the plurality of close-loop induction circuits, so that when the magnetic induction dart D1 is close to the board surface S1, a plurality of induction signals S11 are generated through electromagnetic induction.

The induction circuits 12-1 to 12-N of the present disclosure can detect magnetic flux lines of the magnetic induction dart D1. When the magnetic flux lines of the magnetic induction dart D1 move to the board surface S1, the changes of magnetic flux of the close-loop induction circuits correspondingly generate the plurality of induction signals S11.

Furthermore, the sensing circuit 14 is configured to receive the induction signals S11 from the induction circuits 12-1 to 12-N, and determine a location of the magnetic induction dart D1 block on the induction signals S11. For example, the sensing circuit 14 can determine the induction area A1 or the target area B1 in which the magnetic induction dart D1 is located, and a scoring result can be counted accordingly.

In some embodiments, the induction signals S11 are a plurality of induced voltages, and the sensing circuit 14 can be configured to compare the induced voltages based on magnitudes of the induced voltages so as to determine the location of the magnetic induction dart D1. In other embodiments, the induction signals S11 can be a plurality of induction currents, and the sensing circuit 14 can determine the location of the magnetic induction dart D1 based on the magnitudes or directions of the induction currents.

The sensing circuit 14 may include a voltage detector circuit and an amplifier to amplify voltage signals when the induced voltage is small, and the sensing circuit 14 compares the magnitudes of the induced voltages. In other embodiments, the sensing circuit 14 can include a current detector circuit and an amplifier to amplify current signals when the induced voltage is small, and the sensing circuit 14 determines the magnitudes and directions of the induction currents.

Therefore, since induced voltages or induction currents are used for determination in the present disclosure, compared with conventional art in which magnetic flux variation is used, the present disclosure utilizes an amplifier to amplify the signal, and compares the current phase or voltage, so that the detection result will not be affected by noises. Furthermore, the sensing circuit 14 may further include a processor, a microprocessor, or a microcontroller to determine the location of the magnetic induction dart and to count a scoring result based on the determined location at the same time.

For example, as shown in FIG. 4 and FIG. 6, the magnetic induction dart board 1 of the present disclosure may further include a display device 15, which may be a display or a plurality of light sources. When the sensing circuit 14 finishes counting, the sensing circuit 14 can generate the indication signal S12 that includes the scoring result. The indication signal S12 is used to control the display device 15 to display a score currently acquired by a user.

The display device 15 may further include a user interface 150. The user can set a number that the sensing circuit 14 needs to count in each round through the user interface 150 according to a number that a dart thrower can throw in each round. For example, each player can throw darts for three times in each round, and the sensing circuit 14 is set to count three times in each round. Therefore, after each time the player finishes throwing the magnetic induction dart D1, the sensing circuit 14 can automatically count a score until the position information reaches a predetermined number (for example, three, but it is not limited thereto). The score of each count can be added up to generate a total score that the user has obtained for the round.

As shown in FIG. 8A, FIG. 8B, and FIG. 8C, the induction circuits 12-1 to 12-N can include a plurality of first induction circuits 121-1 to 121-M and a plurality of second induction circuits 122-1 to 122-L. The first induction circuits 121-1 to 121-M are concentrically disposed with respect to a center C of the board surface S1 to form a plurality of first induction areas C1 to C5. The second induction circuits 122-1 to 122-L are radially disposed with respect to a center C of the board surface S1 to form a plurality of second induction areas F 1 to FX. The quantities as shown here are only exemplary, and the present disclosure is not limited thereto.

Therefore, when the magnetic induction dart D1 is moved to the board surface S1, the sensing circuit 14 determines which of the first induction areas C1 to C5 the magnetic induction dart D1 is located in through detecting the magnitudes of the induced voltages or the induction currents of the first induction circuits 121-1 to 121-M. At the same time, the sensing circuit 14 determines which of the second induction areas F 1 to FX the magnetic induction dart D1 is located in through detecting the magnitudes of the induced voltages or the induction currents of the second induction circuits 122-1 to 121-L.

In detail, when the magnetic induction dart D1 is located in the first induction area C5, the first induction circuit 121-1 and the first induction circuit 121-2 respectively generate induced voltages or induction currents that have opposite directions or differences in magnitude. Therefore, by the determining results of the abovementioned two steps, the location of the magnetic induction dart D1 can be accurately determined, thereby simplifying a wiring design of the induction circuits of the dart board.

Referring to FIG. 8C, the induction circuits 12-1 to 12-N can include a plurality of third induction circuits 123-1 to 123-0 and a plurality of fourth induction circuits 124-1 to 124-P. The third induction circuits 123-1 to 123-0 are disposed in parallel to the board surface S1 along a first direction D1, and the fourth induction circuits 124-1 to 124-P are disposed in parallel to the board surface S1 along a second direction D2, thereby forming a plurality of third induction areas G1 to GX. The first direction D1 and the second direction D2 are orthogonal to each other.

Therefore, when the magnetic induction dart D1 is moved to the board surface S1, the sensing circuit 14 determines which of the third induction areas G1 to GX the magnetic induction dart D1 is located in through detecting the magnitudes of the induced voltages or the induction currents of the third induction circuits 123-1 to 123-0 and the fourth induction circuits 124-1 to 124-P. dart induced voltage.

In detail, when the magnetic induction dart D1 is located in the third induction area G1, the third induction circuit 123-1 and the third induction circuit 123-2 respectively generate induced voltages or induction currents that have opposite directions or differences in magnitude. The fourth induction circuit 124-1 and the fourth induction circuit 124-2 respectively generate induced voltages or induction currents that have opposite directions or differences in magnitude. Therefore, by the determining results of the abovementioned two steps, the location of the magnetic induction dart D1 can be accurately determined, thereby simplifying the wiring design of the induction circuits of the dart board.

In addition, the tip unit D12 of this embodiment is disposed at the front of the magnetic induction dart D1, and the magnetic field is provided by the magnetic unit D13. Therefore, the magnetic induction dart D1 does not need to be magnetized often, and can be conveniently maintained.

When the tip unit D12 is damaged, only the tip unit D12 needs to be replaced, and both the magnetic unit D13 and the barrel D11 do not need to be replaced. The barrel D11 of the magnetic induction dart D1 is made of non-magnetic conductive material, so that when the magnetic induction dart D1 is thrown to the board surface S1, misjudgments and scoring errors due to the barrel D11 crossing into other induction areas can be avoided.

### Beneficial Effects of the Embodiments

In conclusion, the magnetic induction dart provided by the present disclosure can utilize the magnetic unit to provide magnetic field for a long period of time, does not need magnetization often, and is easy to maintain. Furthermore, when the dart is thrown toward the magnetic induction dart board, a misjudgment does not easily occur. In addition, costs can be reduced by dispensing with the need for complex wiring of the induction area where the magnetic dart is located.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A magnetic induction dart, comprising:
a barrel including a first terminal and a second terminal, and the first terminal and the second terminal of the barrel being oppositely disposed, wherein the first terminal of the barrel has a recess;
a tip unit being disposed at the first terminal of the barrel; and
a magnetic unit being disposed in the recess of the first terminal of the barrel, wherein the tip unit is fixedly disposed in the barrel, and the tip unit is in contact with the magnetic unit in the recess;
wherein the first terminal of the barrel further includes a first fixing structure, the tip unit includes a first end and a second end, and the first end of the tip unit includes a second fixing structure, wherein the tip unit is fixedly connected to the first fixing structure of the barrel through the second fixing structure.

2. The magnetic induction dart according to claim 1, wherein the tip unit is a metal needle, the first fixing structure is a first screw thread structure, and the second fixing structure is a second screw thread structure.

3. The magnetic induction dart according to claim 1, wherein the tip unit includes a metal strip and an insulation layer, and the insulation layer is disposed at an exterior of the metal strip, wherein, when the tip unit is disposed at the first terminal of the barrel, the metal strip of the tip unit is in contact with the magnetic unit.

4. A magnetic induction darting system, comprising:
a magnetic induction dart including:
a barrel including a first terminal and a second terminal, and the first terminal and the second terminal of the barrel being oppositely disposed, wherein the first terminal of the barrel has a recess;
a tip unit being disposed at the first terminal of the barrel; and
a magnetic unit being disposed in the recess of the first terminal of the barrel, wherein the tip unit is fixedly disposed in the barrel, and the tip unit is in contact with the magnetic unit in the recess;
wherein, the first terminal of the barrel further includes a first fixing structure, the tip unit includes a first terminal and a second terminal, and the first end of the pin unit includes a second fixing structure, wherein the pin unit is fixedly connected to the first fixing structure of the barrel through the second fixing structure; and
a magnetic induction dart board including:
a board unit including a plate, wherein the plate has a board surface and a back surface;
a plurality of induction circuits being disposed in parallel with the board surface, and the plurality of induction circuits being in an intersecting arrangement with each other to form a plurality of induction areas covering a plurality of target areas of the board surface; and
a sensing circuit electrically connected to the plurality of induction circuits such that the plurality of induction circuits form a plurality of close-loop induction circuits, wherein, when the magnetic induction dart is close to the board surface, a plurality of induction signals are generated through electromagnetic induction dart;
wherein the sensing circuit is configured to receive the plurality of induction signals from the plurality of induction circuits, and determines a location of the magnetic induction dart based on the plurality of induction signals.

5. The magnetic induction dart system according to claim 4, wherein the barrel is made of at least one non-magnetic material, and the tip unit is a metal strip.

6. The magnetic induction dart system according to claim 4, wherein the tip unit includes a metal strip and an insulation layer, and the insulation layer is disposed at an exterior of the metal strip, wherein, when the tip unit is disposed at the first terminal of the barrel, the metal strip of the tip unit is in contact with the magnetic unit.

7. The magnetic induction darting system according to claim 4, wherein the plurality of induction signals are a plurality of induced voltages, and the sensing circuit compares magnitudes of the induced voltages to determine the location of the magnetic induction dart.

8. The magnetic induction darting system according to claim 4, wherein the plurality of induction circuits includes a plurality of first induction circuits and a plurality of second induction circuits, the plurality of first induction circuits are concentrically disposed with respect to a center of the board surface, and the plurality of second induction circuits are radially disposed with respect to the center of the board surface.
